(19) United States
(12) Patent Application Publication
(10) Pub. No.: US 2013/0202047 A1
(43) Pub. Date: Aug. 8, 2013

(54) APPARATUS AND METHOD FOR VIDEO ENCODING/DECODING

(71) Applicants: Jinhan Song, Seoul (KR); Jeongyeon Lim, Seongnam-si (KR); Jongki Han, Seoul (KR); Yunglyul Lee, Seoul (KR); Joohee Moon, Seoul (KR); Haekwang Kim, Seoul (KR); Byeungwoo Jeon, Seongnam-si (KR); Myung Hun Jang, Seoul (KR)

(72) Inventors: Jinhan Song, Seoul (KR); Jeongyeon Lim, Seongnam-si (KR); Jongki Han, Seoul (KR); Yunglyul Lee, Seoul (KR); Joohee Moon, Seoul (KR); Haekwang Kim, Seoul (KR); Byeungwoo Jeon, Seongnam-si (KR); Myung Hun Jang, Seoul (KR)

(73) Assignee: SK TELECOM CO. LTD., Seoul (JP)

(21) Appl. No.: 13/880,004

(22) PCT Filed: Oct. 18, 2011
(86) PCT No.: PCT/KR11/07736

§ 371 Date: Apr. 17, 2013

(30) Foreign Application Priority Data
Oct. 18, 2010 (KR) 10-2010-0101439

(51) Int. Cl. H04N 7/26

(52) U.S. Cl. CPC H04N 19/00684
USPC 375/240.16

(57) ABSTRACT

A video encoding/decoding apparatus includes a video encoder and a video decoder. The video encoder is configured to set up motion vector resolutions differentiated by search areas centered on a prediction motion vector of a current block, perform a motion estimation with a resolution corresponding to each of the search areas to generate a motion vector, and encode a differential motion vector between the generated motion vector and the prediction motion vector. The video decoder is configured to extract the differential motion vector from a bitstream, and decode the extracted differential motion vector with a resolution corresponding to a search area where the differential motion vector belongs to among the search areas.

### CROSS-REFERENCE TO RELATED APPLICATION

The instant application is the US national phase of PCT/KR2011/007736, filed Oct. 18, 2011, which claims priority to Korean Patent Application No. 10-2010-0101439, filed on Oct. 18, 2010. The above-listed applications are hereby incorporated by reference in their entirety.

### TECHNICAL FIELD

The present disclosure relates to video encoding/decoding apparatus and method

### BACKGROUND

The statements in this section merely provide background information related to the present disclosure and may not necessarily constitute prior art.

FIG. 1 is a diagram showing a configuration of an encoder based on H.264/AVC. As shown in FIG. 1, the encoder based on H.264/AVC encodes input video data by performing intra prediction/inter prediction, transform/quantization, entropy coding and the like. The intra prediction is a process for removing temporal redundancy, and the inter prediction is a process for removing spatial redundancy. Data, from which redundancy is removed, is compressed through a transform/quantization process. The compressed data is produced into a bitstream through an entropy encoder.

A video typically may include a series of pictures (or frames or images) each of which is divided into predetermined areas, such as macroblocks. The macroblock is the standard unit of video encoding and decoding. Macroblocks may be classified into intra macroblocks and inter macroblocks depending on the encoding method. The intra macroblock means a macroblock encoded through an intra prediction coding method that is an intra frame prediction coding. The intra prediction coding is adapted to generate a predicted block by predicting a pixel of a current block using pixels of reconstructed blocks that underwent previous encoding and decoding within a current picture where the current encoding is performed and then encode a differential value between the predicted block and the current block. The inter macroblock means a macroblock encoded through an inter prediction or inter frame prediction coding. The inter prediction coding is adapted to generate the predicted block by predicting the current block in the current picture through referencing one or more past (previous) pictures or future (subsequent) pictures and then encode the differential value of the predicted block from the current block. Here, the picture that is referenced in encoding or decoding the current picture (or current frame or current image) is called a reference picture (or reference frame or reference image).

Referring to FIG. 1, the inter predictor performs inter prediction on a macroblock that is divided in units of 16×16, 16×8, 8×16, 8×8, 8×4, 4×8, and 4×4 blocks. The inter prediction finds a block with the highest coding efficiency from a previously coded frame, and encodes a difference between the found block and a block to be currently coded. The process of finding the block with the high coding efficiency is a process of predicting a motion vector. The process of predicting the motion vector of the current block selects a motion vector having the lowest cost as an optimal motion vector among many candidate motion vectors, based on Equation 1 below.

M_cos t=Distortion+λ•Rate Equation 1

In Equation 1, Distortion is the sum of absolute values of pixel differences between the current block and the block indicated by the motion vector, Rate is a predicted value of bits generated when encoding the predicted motion vector, and λ is Lagrange multiplier.

The process of encoding the predicted motion vector is as follows. A calculation is first performed on a prediction motion vector (PMV) predicted from adjacent blocks of the current block followed by another calculation of a differential vector between the PWM and the motion vector of the current block.

When predicting the motion vector, motion estimation may be performed in units of integers. However, for more accurate motion estimation, motion estimation may be performed in units of ½ pixels or ¼ pixels (i.e., non-integer pixels). This is because image does not move only in units of integer pixels, but can move in units of ½ pixels or ¼ pixels. Therefore, if motion estimation is performed only in units of integer pixels, coding efficiency is lowered in images that move in units of ½ pixels or ¼ pixels.

Considering this fact, JM reference software, which is an existing video codec, predicts motion vectors in units of integer pixels, ½ pixels, and finally ¼ pixels, and compresses signals by using a motion vector of a resolution having highest coding efficiency with the block to be currently coded. In addition, KTA reference software can detect more accurate motion by predicting a motion vector in units of integer pixels to ⅛ pixels so as to predict the motion vector more accurately. However, an reference image does not have ½ pixel or ¼ pixel values, but integer pixel values. Therefore, ½ pixel or ¼ pixel values are produced using the given integer pixel values.

As for the method for producing ½ pixel and ¼ pixel values in JM reference software, ½ pixel values are generated by using six integer pixel values around the ½ pixel, as shown in FIG. 2. In addition, the ¼ pixel is obtained by performing bilinear interpolation on ½ pixels and integer pixels around the ¼ pixel. On the other hand, in KTA reference software, motion vectors can be generated in units of up to ⅛ pixels. The method is shown in FIG. 3.

A differential motion vector encoding method can be performed through tables of FIGS. 4 and 5. FIGS. 4 and 5 show codebooks for encoding a differential motion vector when the motion vector resolution is used in units of up to ¼ and ⅛ pixels, respectively. As for the encoding method, differential motion vectors of x-axis and y-axis are calculated, and a bit string is generated using a code number corresponding to a relevant differential motion vector among values presented in FIGS. 4 and 5.

FIG. 6 is a diagram showing a configuration of a decoder based on H.264/AVC. A block data value received from the encoder undergoes entropy decoding, inverse quantization, and inverse transform in sequence to generate a differential block signal value with quantization error. When the current block is an inter-prediction-coded block, the differential motion vector value is generated by using the codebooks of FIGS. 4 and 5, and the motion vector value is generated by calculating PMV in the same manner as in the encoder. A block acquired by using the generated motion vector from the reference image is added to the differential block signal value with the quantization error to obtain a reconstructed image.

As can be seen from FIG. 4 or 5, in the typical compression standard, long codewords are used for encoding all motion vectors with various resolutions and for encoding even the small motion vectors. This will increase the size of data generated by encoding the motion vector, which lowers coding efficiency. For example, referring to FIG. 4, when the differential motion vector is (3,2), a bit string ‘000011000’, whose code number is ‘3’, is used for encoding ‘3’, and a bit string ‘000010000’, whose code number is ‘15’, is used for encoding ‘2’. The long codewords are used for encoding the small motion vector because codewords for encoding motion vectors of ½ pixel-unit resolution and ¼ pixel-unit resolution and codewords for encoding motion vectors of integer pixel-unit resolution are used together.

The prediction of the motion vector with high resolution has an advantage in that it can find such a reference block that has high correlation with the currently coded block. However, the inventors have noted that the compression efficiency may be lowered due to the use of variable-length codeword considering vectors of all resolutions encompassing values of motion vectors from low to high resolutions. For example, assuming a specific frame permits encoding with the use of motion vectors exclusively in units of integer pixels or ½ pixels when the variable length codebook is used to have all resolutions considered from the integer pixel unit to ⅛ pixel unit, the codewords for ¼ and ⅛ pixels are not used and lengthen the variable-length codewords of frequently used integer pixels and ½ pixel coded vectors. As a result, the coding efficiency may be lowered. In some contrary cases, due to the characteristics of the internal pixel values of certain frames, compression efficiency can be increased when using the variable-length codewords considering motion vectors of all resolutions from the integer to ⅛ pixel units.

### SUMMARY

In some embodiments, a video encoding/decoding apparatus comprises a video encoder and a video decoder. The video encoder is configured to set up motion vector resolutions differentiated by search areas centered on a prediction motion vector of a current block, perform a motion estimation with a resolution corresponding to each of the search areas to generate a motion vector, and encode a differential motion vector between the generated motion vector and the prediction motion vector. The video decoder is configured to extract the differential motion vector from a bitstream, and decode the extracted differential motion vector with a resolution corresponding to a search area where the differential motion vector belongs to among the search areas.

In some embodiments, a differential motion vector encoding method comprises setting up motion vector resolutions differentiated by the search areas centered on a prediction motion vector of a current block, performing motion estimation with the resolution corresponding to each of the search areas to generate a motion vector, calculating a differential motion vector between the generated motion vector and the prediction motion vector, and encoding the calculated differential motion vector.

In some embodiments, a differential motion vector decoding method comprises dividing search areas in accordance with threshold values, setting up motion vector resolutions differentiated by the search areas, extracting a differential motion vector from a bitstream, and decoding an extracted differential motion vector with the resolution corresponding to a search area where the differential motion vector belongs to among the search areas.

### DESCRIPTION OF DRAWINGS

FIG. 1 is a diagram schematically showing a configuration of an encoder based on H.264/AVC;

FIG. 2 is a diagram showing a method for generating ½ pixel value and ¼ pixel value in JM reference software;

FIG. 3 is a diagram showing a method for estimating a motion vector up to ⅛ pixel unit in KTA reference software;

FIG. 4 is a diagram showing an example of a codebook for encoding a differential motion vector of ¼ pixel unit;

FIG. 5 is a diagram showing an example of a codebook for encoding a differential motion vector of ⅛ pixel unit;

FIG. 6 is a diagram schematically showing a configuration of a decoder based on H.264/AVC;

FIG. 7 is a diagram schematically showing a differential motion vector encoding apparatus according to one or more embodiments of the present disclosure;

FIG. 8 is a diagram two-dimensionally showing division of search areas centered on a prediction motion vector of a current block;

FIG. 9 is a diagram one-dimensionally showing division of search areas centered on a prediction motion vector of a current block;

FIG. 10 is a diagram showing an exemplary case where the farther the distance gets from a prediction motion vector of a current block, the smaller number of motion vector resolutions are available for each search area;

FIG. 11 is a diagram showing an example of a codebook for encoding a differential motion vector in the case of FIG. 10;

FIG. 12 is a diagram showing another exemplary case where the farther the distance gets from a prediction motion vector of a current block, the larger number of motion vector resolutions are available for each search area;

FIG. 13 is a diagram showing an example of a codebook for encoding a differential motion vector in the case of FIG. 12;

FIG. 14 is a diagram showing an example in which various types of available resolutions distributed by search areas centered on a prediction motion vector of a current block are arbitrarily set, regardless of distances;

FIG. 15 is a diagram showing an example of a codebook for encoding a differential motion vector in the case of FIG. 14;

FIG. 16 is a diagram showing an example in which division of search areas centered on a prediction motion vector of a current block is set differently along x-axis and y-axis;

FIG. 17 is a diagram showing an example which determines motion vectors by search areas with respect to x-axis of FIG. 16;

FIG. 18 is a diagram showing an example of a codebook for encoding a differential motion vector in the case of FIG. 17;

FIG. 19 is a diagram showing an example which determines motion vectors by search areas with respect to y-axis of FIG. 16;

FIG. 20 is a diagram showing an example of a codebook for encoding a differential motion vector in the case of FIG. 19;

FIG. 21 is a diagram schematically showing a differential motion vector decoding apparatus according to at least one embodiment of the present disclosure;

FIG. 22 is a diagram schematically showing a differential motion vector decoding apparatus according to at least one embodiment of the present disclosure;

FIG. 23 is a flow diagram showing a differential motion vector encoding method which is performed by the differential motion vector encoding apparatus of FIG. 7;

FIG. 24 is a diagram showing an example where search areas are set in a rectangular shape;

FIG. 25 is a diagram showing an example where search areas are set in a diamond shape;

FIG. 26 is a diagram exemplarily showing a change of a syntax due to a threshold value to be transmitted to a decoder;

FIG. 27 is a flow diagram showing a differential motion vector decoding method which is performed by the differential motion vector decoding apparatus of FIG. 21;

FIG. 28 is a flow diagram showing a differential motion vector decoding method which is performed by the differential motion vector decoding apparatus of FIG. 22,

FIG. 29 is a diagram showing an example where all currently encoded threshold values are equally used in various reference frames; and

FIG. 30 is a diagram showing an exemplary case where different threshold values are used in various reference frames.

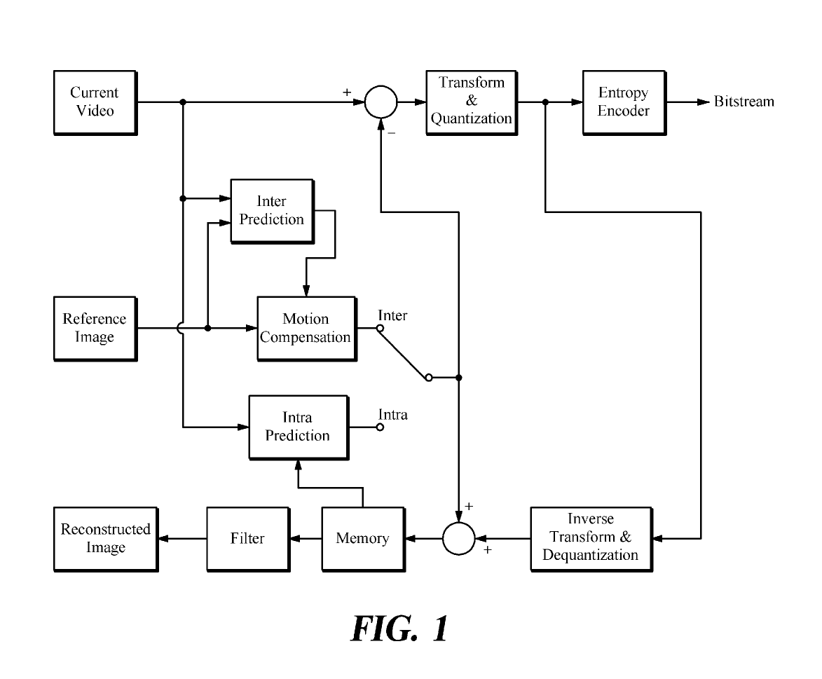

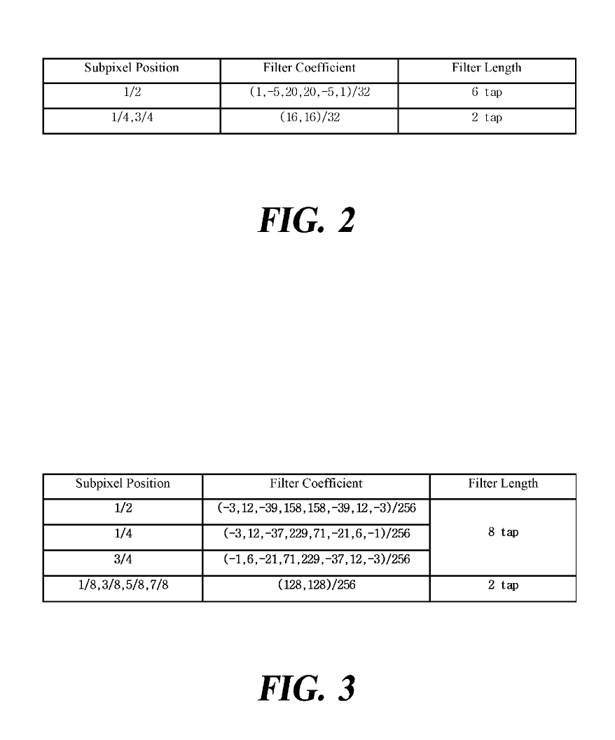

### DETAILED DESCRIPTION

Some embodiments of the present disclosure provide differential motion vector encoding/decoding apparatus and method, in which motion vectors are predicted with resolutions differentiated by search areas, and a differential motion vector is adaptively encoded/decoded with a corresponding resolution, thereby increasing compression and/or reconstruction efficiency.

Hereinafter, at least one embodiment of the present disclosure will be described in detail with reference to the accompanying drawings. In the following description, like reference numerals designate like elements although the reference numerals are shown in different drawings. Further, in the following description of the present embodiments, a detailed description of known functions and/or configurations incorporated herein will be omitted for the purpose of clarity and for brevity.

Additionally, in describing various components of the present disclosure, terms like first, second, A, B, (a), and (b) are used solely for the purpose of differentiating one component from another, but one of ordinary skill would understand the terms do not imply or suggest the substances, order or sequence of the components. If a component is described as ‘connected’, ‘coupled’, or ‘linked’ to another component, one of ordinary skill would understand the components are not necessarily directly ‘connected’, ‘coupled’, or ‘linked’ but also are indirectly ‘connected’, ‘coupled’, or ‘linked’ via at least one additional third component.

Hereinafter, a video encoding apparatus and/or a video decoding apparatus in accordance with some embodiments described below may be user terminals such as a personal computer (PC), a notebook computer, a tablet, a personal digital assistant (PDA), a game console, a portable multimedia player (PMP), a PlayStation Portable (PSP), a wireless communication terminal, a smart phone, a TV, a media player, and the like. A video encoding apparatus and/or a video decoding apparatus according to one or more embodiments may correspond to server terminals such as an application server, a service server and the like. A video encoding apparatus and/or a video decoding apparatus according to one or more embodiments may correspond to various apparatuses each including (a) a communication unit apparatus such as a communication modem and the like for performing communication with various types of devices or a wired/wireless communication network, (b) a memory for storing various types of programs and data for encoding or decoding a video, or performing an inter or intra prediction for the encoding or decoding, and (c) a microprocessor and the like for executing the program to perform an operation and control. According to one or more embodiments, the memory comprises a computer-readable recording/storage medium such as a random access memory (RAM), a read only memory (ROM), a flash memory, an optical disk, a magnetic disk, a solid-state disk , and the like. According to one or more embodiments, the microprocessor is programmed for performing one or more of operations and/or functionality described herein. According to one or more embodiments, the microprocessor is implemented, in whole or in part, by specifically configured hardware (e.g., by one or more application specific integrated circuits or ASIC(s)).

Further, a video encoded into a bitstream by the video encoding apparatus may be transmitted in real time or non-real-time to the video decoding apparatus through wired/wireless communication networks such as the Internet, wireless short range or personal area network (WPAN), wireless local area network (WLAN), WiBro (wireless broadband, aka WiMax) network, mobile communication network and the like or through various communication interfaces such as a cable, a universal serial bus (USB) and the like. According to one or more embodiments, the bit stream is decoded in the video decoding apparatus and reconstructed and reproduced as the video. According to one or more embodiments, the bit stream is stored in a computer-readable recording/storage medium.

The technology described herein is not applied with limitation to motion vector prediction units (for example, macroblocks, 16×16, 16×8, 8×16, 8×8, 4×8, 8×4, 4×4) used in the existing H.264 standard or KTA reference software, and the size of motion vector estimation blocks also is not limited. In addition, the technology of the present disclosure can also be used when the motion vector prediction unit has a square shape, a rectangular shape, a triangular shape, and other various shapes.

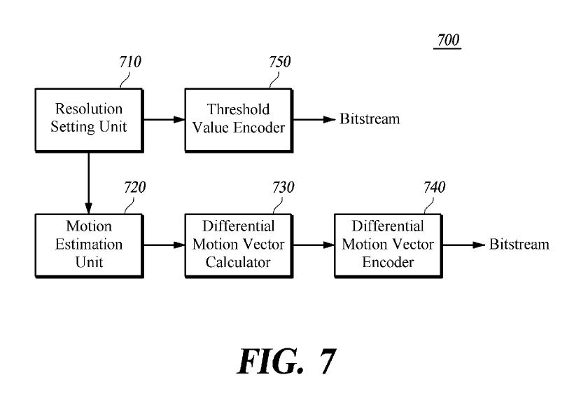

FIG. 7 is a diagram schematically showing a differential motion vector encoding apparatus according to one or more embodiments of the present disclosure. The differential motion vector encoding apparatus 700 according to at least one embodiment of the present disclosure may include a resolution setting unit 710, a motion estimation unit 720, a differential motion vector calculator 730, a differential motion vector encoder 740 and a threshold value encoder 750.

The resolution setting unit 710 sets up motion vector resolutions differentiated by search areas centered on a prediction motion vector (PMV) of a current block. In the existing technique for encoding the differential motion vector, the motion vectors having the same resolution are used in all areas centered on the prediction motion vector. However, the differential motion vector encoding apparatus 700 according to at least one embodiment of the present disclosure is configured to estimate motion vectors having different resolutions in different search areas centered on the prediction motion vector, as opposed to the existing differential motion vector encoding method. For this purpose, the resolution setting unit 710 may set up resolutions by search areas such that the motion vector resolution is lowered as the distance from the search area to the prediction motion vector increases, or may set up resolutions by search areas such that the motion vector resolution is increased as the distance from the search area to the prediction motion vector of the current block increases. Alternatively, the present disclosure is not limited thereto, and available resolutions can be variously set up according to the distance from the search area to the prediction motion vector of the current block. In addition, different motion vector resolutions can be set differently in different directions centered on the prediction motion vector of the current block.

In at least one embodiment, the resolution setting unit 710 can calculate threshold values of respective search areas by using the current image and the reference image. The present disclosure does not limit the method for calculating the threshold values, and can generate a table (codebook) for encoding the differential motion vector by using one or more threshold values predetermined for the corresponding one or more search areas.

The motion estimation unit 720 generates the motion vector by performing motion estimation with the resolutions set correspondingly to the respective search areas by the resolution setting unit 710.

The differential motion vector calculator 730 calculates the differential motion vector between the motion vector generated by the motion estimation unit 720 and the prediction motion vector.

The differential motion vector encoder 740 encodes the differential motion vector, which is calculated by the differential motion vector calculator 730, with the resolution corresponding to the motion vector generated by the motion estimation unit 720, in a bitstream.

The threshold value encoder 750 encodes the threshold values of the respective search areas with the highest resolution of the corresponding search area and transmits the encoded values on a bitstream to the decoder. In some embodiments, the outputs from the threshold value encoder 750 and the differential motion vector encoder 740 are included in a single bitstream. In at least one embodiment, instead of notifying the decoder of the threshold values in the respective search areas through the threshold value encoder 750, the resolution setting unit 710 may be configured to set up motion vector resolutions differentiated by search areas according to threshold values prearranged with the decoder.

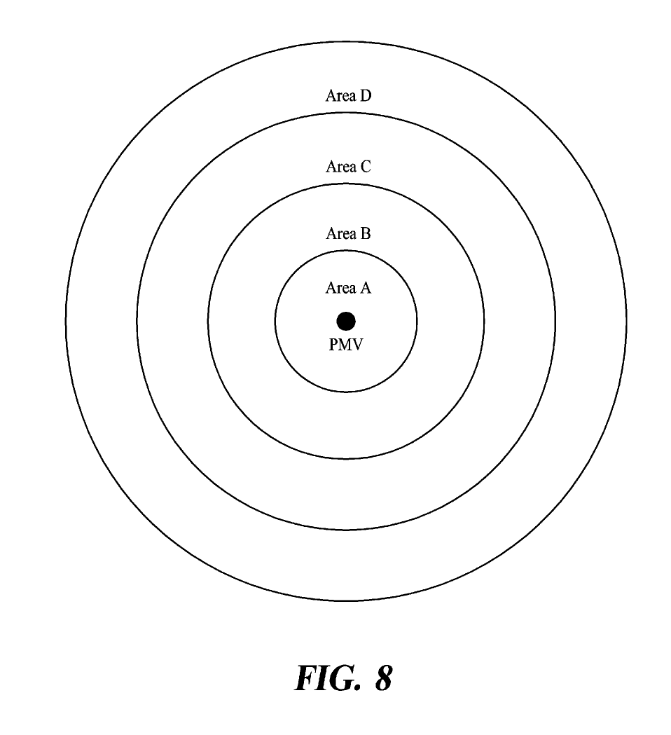

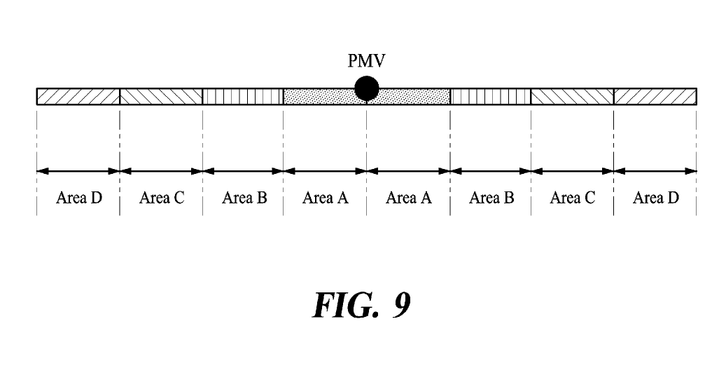

FIG. 8 is a diagram two-dimensionally showing the division of the search areas centered on the prediction motion vector of the current block, and FIG. 9 is a diagram one-dimensionally showing the division of the search areas centered on the prediction motion vector of the current block. As shown in FIGS. 8 and 9, the search areas for estimating the motion vector can be divided according to the distance from the prediction motion vector of the current block. Although FIGS. 8 and 9 show that the respective search ranges are at the same interval, i.e., search areas, or areas, A-D have the same width, the present disclosure is not limited thereto, and the respective search areas may be set at different intervals.

Such divided search areas respectively have motion vectors having different resolutions. For example, an area A has a motion vector encoding resolution of up to ⅛ pel (i.e., ⅛ pixel unit); area B up to ¼ el (i.e., ¼ pixel unit); area C up to ½ pel (i.e., ½ pixel unit); and area D encodes the motion vector with integer motion vector resolutions.

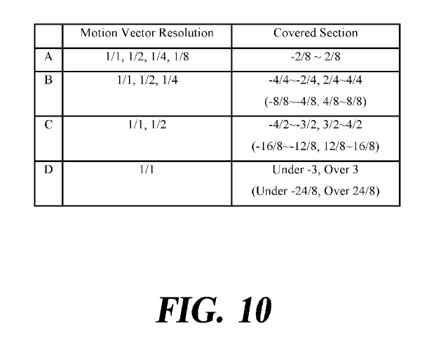

FIG. 10 is a diagram showing an exemplary case where the farther the distance between the search area and the prediction motion vector of the current block gets, the smaller number of motion vector resolutions are available. As shown in FIG. 10, the resolution setting unit 710 may be configured to estimate the motion vectors considering the maximum of ⅛ resolution in area (i.e., search area) A, ¼ resolution in area B, ½ resolution in area C, and 1/1 resolution in area D. For example, in generating differential motion vectors on ⅛ resolution, the differential motion vectors with the magnitudes being in a range (i.e., Covered Section) between threshold values— 2/8 and 2/8 may be classified into area A; the differential motion vectors with magnitudes in between threshold values ⅜ and 8/8 and between threshold values −⅜ and − 8/8 into area B; the differential motion vectors with magnitudes in between threshold values 9/8 and 16/8 and between threshold values − 9/8 and − 16/8 into area C; and the differential motion vectors with magnitudes out of the above threshold value ranges into area D. The respective area ranges described herein are merely an illustrative case where ⅛ resolution is considered, and the present disclosure is not limited thereto.

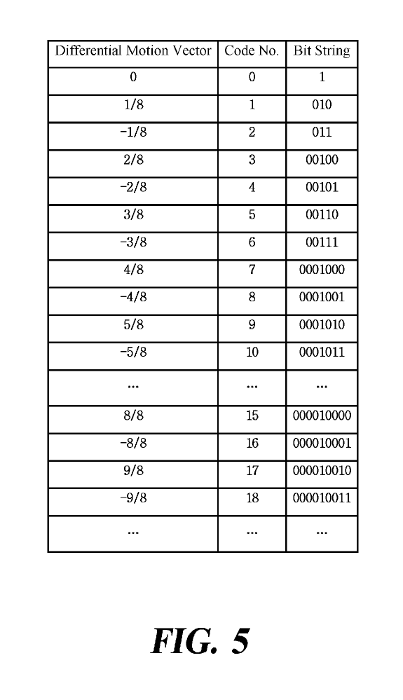

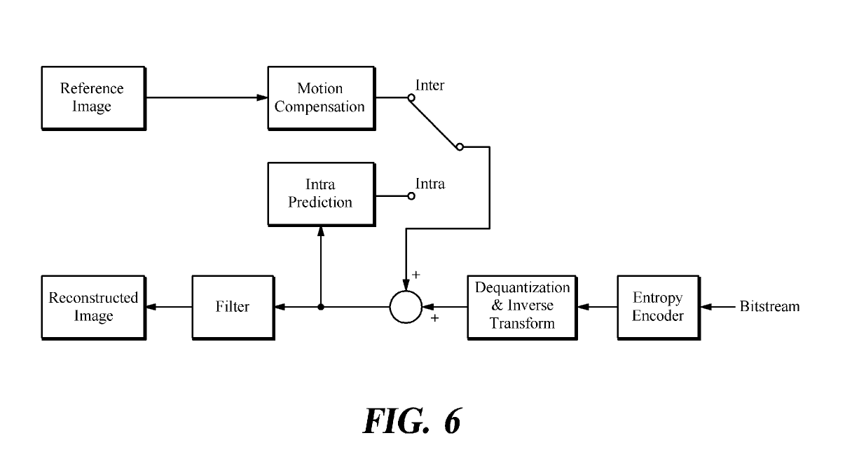

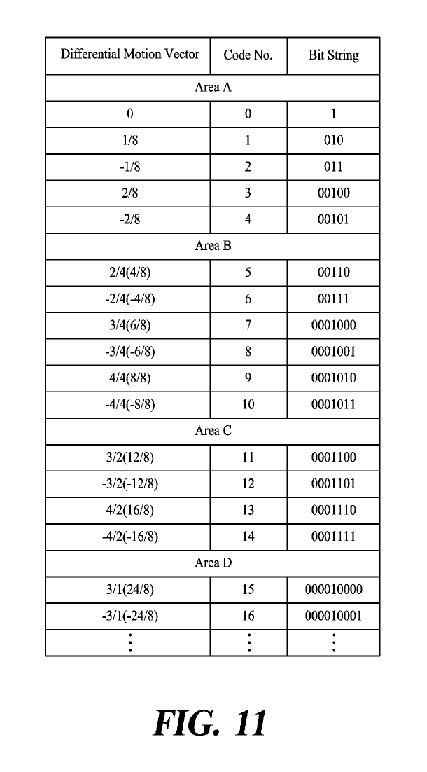

When the areas (i.e., search areas) are set as above, the threshold value encoder 750 encodes the threshold values of the respective search areas in order to notify the set areas to the decoder, the threshold values for use being encoded appropriately on the corresponding maximum resolution. For example, in case of using only up to ¼ pixel resolution, the threshold value encoder 750 encodes the threshold values in units of ¼ pixels before transmitting the same to the decoder. Since up to ⅛ pixel resolution is used in the above-described example, the threshold value encoder 750 encodes the threshold values in units of ⅛ pixels and transmits the same to the decoder. The present disclosure does not limit the method for transmitting the threshold values. If the codebook of FIG. 5 is newly designed by using the above example, the resulting codebook obtained is as shown in FIG. 11.

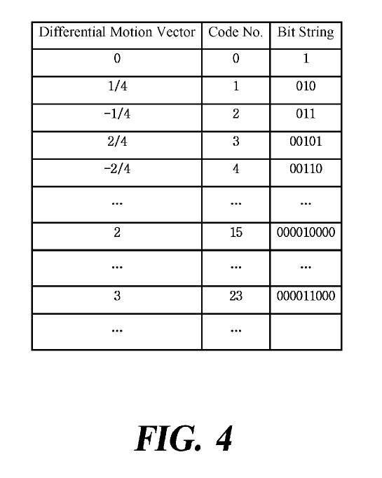

FIG. 11 shows the codebook for encoding the differential motion vector in the case of FIG. 10, and the codebook is generated by exponential Golomb code as shown in FIG. 4 or 5. The exponential Golomb code is a count value obtained by counting the number of 0 until before the first 1 appears, and is a method for calculating how many bits are there to be read after the first 1. Since the codebooks of FIGS. 4 and 5 and the codebook of FIG. 11 in at least one embodiment of the present disclosure are similarly generated, the relations between the code number and the bit string are identical. Only the differential motion vector values (magnitudes) indicated by the respective code numbers are different. In addition, when the differential motion vector is coded with the exponential Golomb code, the code number is first assigned to the value having a small magnitude, and when the magnitudes are equal, the code number is first assigned to a positive value. This method is equally used by the encoder and the decoder.

Although at least one embodiment of the present disclosure exemplifies using the exponential Golomb code to encode the differential motion vector into the bit string, the present disclosure is not limited thereto and other coding methods can be used.

The example of FIG. 10 may be used to generate the codebook of FIG. 11 for the differential motion vector. Since the area A supports up to ⅛ resolution, the motion vectors are densely found as shown in FIG. 11. On the other hand, since the area B finds the motion vectors considering up to ¼ resolution, motion vectors of ⅜, ⅝ and ⅞ corresponding to ⅛ resolution are excluded from the codebook for area B. Since up to ½ resolution is considered in the area C, motion vectors 9/8, 10/8 ( 5/4), 11/8, 13/8, 14/8 ( 7/4), and 15/8 of points corresponding to ¼ resolution and ⅛ resolution are excluded from the codebook for area C. Finally, since only 1/1 (integer pixel) resolution is considered in the area D, points corresponding to ½, ¼ and ⅛ resolutions are excluded from the codebook for area D.

Comparing FIG. 5 with FIG. 11, even though the index number (code number) is the same as 15, the existing algorithm (FIG. 5) indicates the second integer pixel 8/8 (1), but the codebook (FIG. 11) according to at least one embodiment of the present disclosure indicates the fourth integer pixel 3/1 ( 24/8). Subsequently in the area D, the method for encoding the differential motion vector according to at least one embodiment of the present disclosure indexes only the integer pixels to allow proceeding to the next integer pixel for less bits.

Although the foregoing description is related to the case where the longer distance between the search area and the prediction motion vector of the current block brings less available resolutions, the longer distance between the search area and the prediction motion vector of the current block may bring more available resolutions in at least another embodiment.

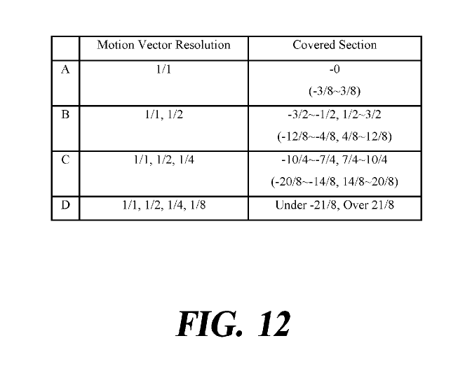

FIG. 12 is a diagram showing an exemplary case where the farther the distance between the search area and the prediction motion vector of the current block gets, the greater number of motion vector resolutions are available. As shown in FIG. 12, motion vectors can be estimated considering up to 1/1 resolution in the area A, up to ½ resolution in the area B, up to ¼ resolution in the area C, and up to ⅛ resolution in the area D. In generating differential motion vectors on ⅛ resolution, the differential motion vector with the magnitudes being in a range between −⅜ and ⅜ may be classified into area A; the differential motion vectors with magnitudes in between 4/8 and 12/8 and between − 4/8 and − 12/8 into area B; the differential motion vectors with magnitudes in between 13/8 and 20/8 and between − 13/8 and − 20/8 into area C; and the differential motion vectors with magnitudes out of the above ranges into area D.

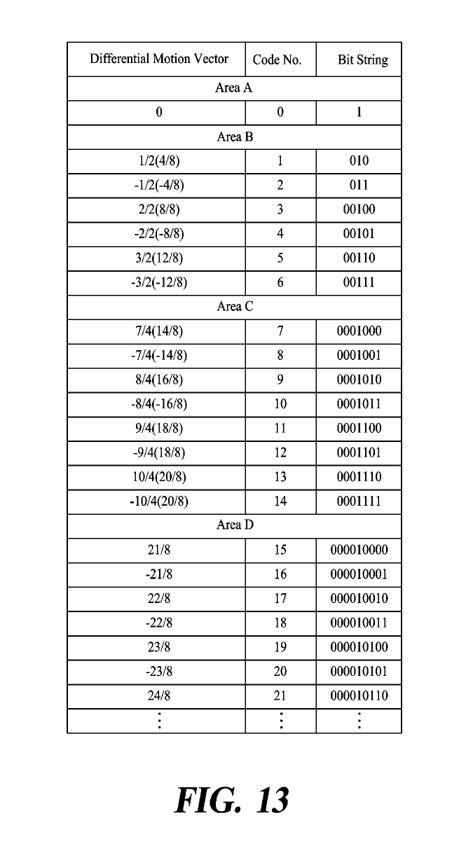

When the codebook for the differential motion vector is generated using the example of FIG. 12, the resulting codebook can be obtained as shown in FIG. 13. Since the area A supports up to 1/1 resolution, motion vector is generated at only 1/1 resolution position as shown in FIG. 13. On the other hand, since the area B finds the motion vector considering up to ½ resolution, the motion vectors ⅝, 6/8 (¾), ⅞, 9/8, and 11/8 corresponding to ¼ and ⅛ resolutions are excluded from the codebook for area B. Since up to ¼ resolution is considered in the area C, the motion vectors 13/8, 15/8, 17/8, and 19/8 corresponding to ⅛ resolution are excluded from the codebook for area C. Finally, since up to ⅛ resolution is considered in the area D, the motion vectors are searched for all resolutions for area D.

In addition, various types of available resolutions distributed by search areas centered on the prediction motion vector of the current block can be arbitrarily set, regardless of distances.

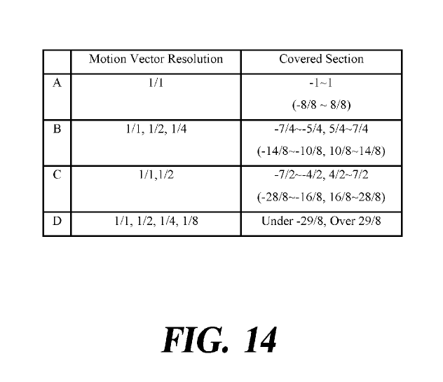

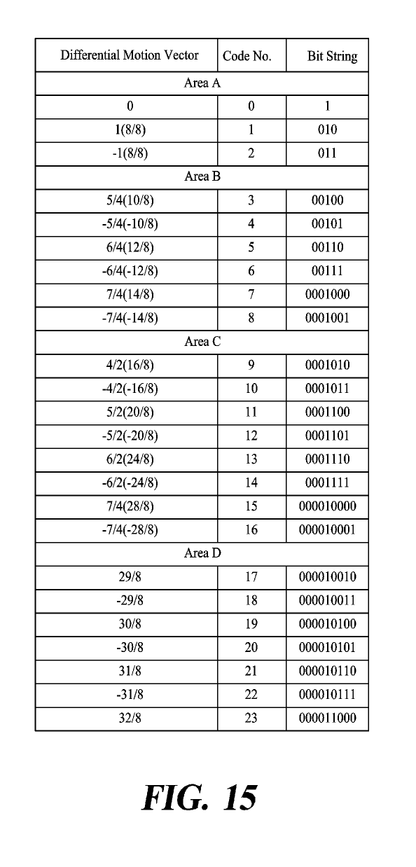

FIG. 14 is a diagram showing an example in which various types of available resolutions distributed by search areas centered on the prediction motion vector of the current block are arbitrarily set, regardless of distances. FIG. 15 is a diagram showing an example of a codebook for encoding a differential motion vector in the case of FIG. 14.

As in the above-described examples, various threshold value settings for the respective areas (i.e., search areas) can be used, and there may be a variety of combinations of motion vector resolutions and threshold values used in the respective areas. The respective threshold values for respective search areas may be encoded by the threshold value encoder 750 before transmission to the decoder, or the transmission of the threshold values may be omitted in such a manner that the encoder and decoder use prearranged threshold values for respective search areas. Information about the combination of the motion vector resolutions and the threshold values used in the respective areas (i.e., search areas) can also be prearranged between the transmitter (e.g., encoder) and the receiver (e.g., decoder). Alternatively, the information about the combination of the resolutions and threshold values may be encoded in the encoder before transmission.

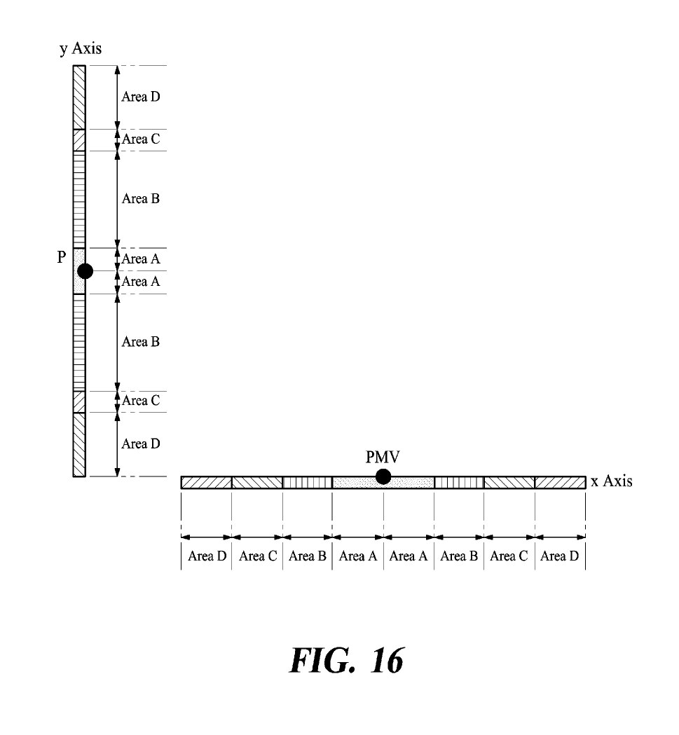

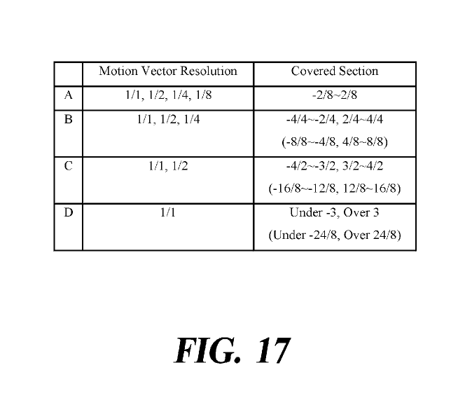

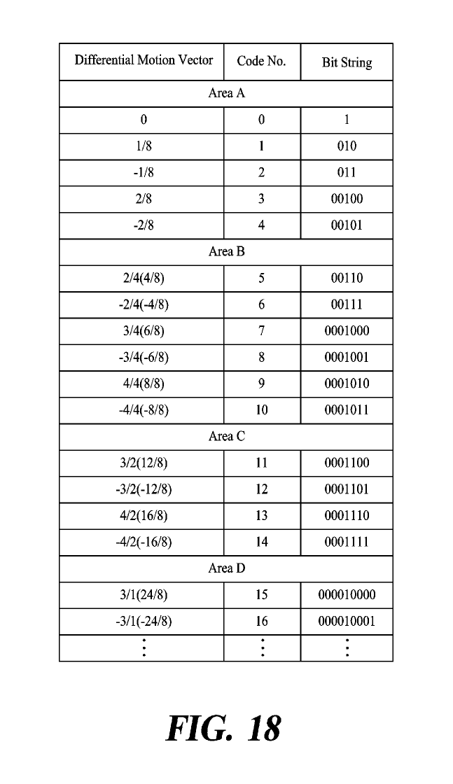

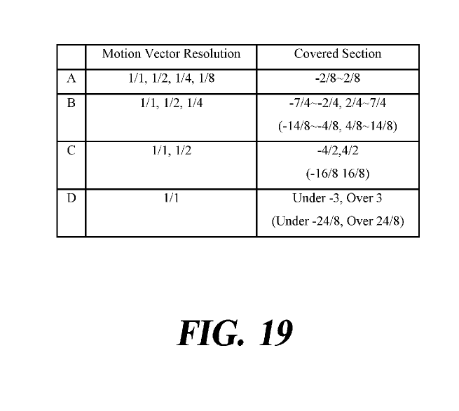

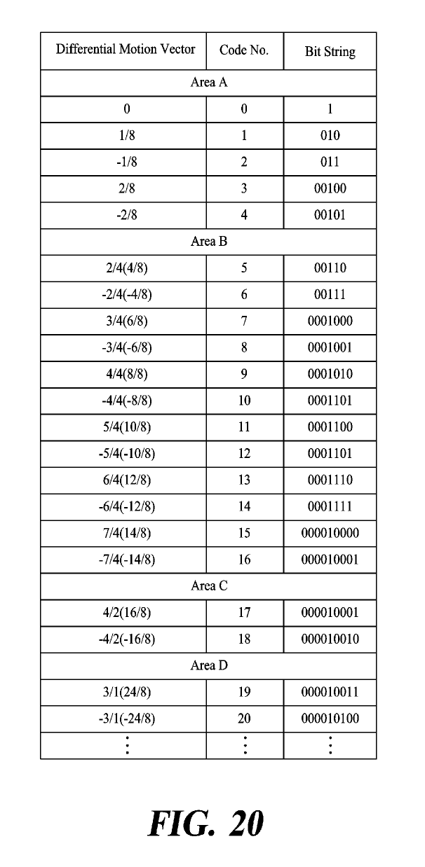

In addition, the search areas may be differently set with respect to x-axis and y-axis as shown in FIG. 16. That is, threshold values used for the same area (search area) on x-axis and y-axis may be different from one another. In this case, motion vector resolutions by search areas on x-axis may be determined for example as shown in FIG. 17, and the codebook for encoding differential motion vectors of x-axis according to at least one embodiment of the present disclosure may be represented as shown in FIG. 18. In addition, motion vector resolutions by search areas on y-axis may be determined for example as shown in FIG. 19, and the codebook for encoding differential motion vectors of y-axis according to at least one embodiment of the present disclosure may be represented as shown in FIG. 20.

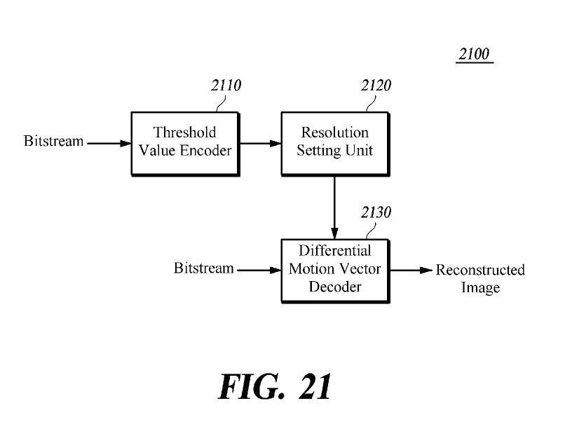

FIG. 21 is a diagram schematically showing a differential motion vector decoding apparatus according to one or more embodiments of the present disclosure. The differential motion vector decoding apparatus 2100 according to at least one embodiment may include a threshold value decoder 2110, a resolution setting unit 2120, and a differential motion vector decoder 2130.

The threshold value decoder 2110 extracts threshold values of respective search areas from a bitstream received from the encoder, and decodes the extracted threshold values. The threshold values used herein are threshold values of the respective search areas set by the encoding apparatus 700 according to at least one embodiment of the present disclosure, and are encoded with the highest resolution among motion vector resolutions available in the respective areas. For example, with respect to area A in FIG. 10, the threshold values 2/8 and − 2/8 are encoded with the with the highest resolution ⅛ among motion vector resolutions 1/1, ½, ¼, ⅛ available in the respective area A.

The resolution setting unit 2120 sets motion vector resolutions differentiated by search areas, based on the respective threshold values decoded by the threshold value decoder 2110. That is, the resolution setting unit 2120 can recognize motion vector resolutions available in the respective search areas set by the differential motion vector encoding apparatus 700, based on the respective decoded threshold values. For example, in a case where the threshold values 2/8 and − 2/8 for the area A of FIG. 10 is extracted from the bitstream and then decoded, the decoder 2100 can see that the covered section of the area A is − 2/8 to 2/8. Since the encoding is done with ⅛, which is the full motion vector resolution available in the area A, the decoder 2100 can know that the motion vector resolutions 1/1, ½ and ¼ lower than the highest resolution of ⅛ are also available in area A.

The differential motion vector decoder 2130 extracts the differential motion vector from the bitstream received from the encoder, and decodes the differential motion vector with the resolutions corresponding to the area where the differential motion vector belongs among the respective areas. In this case, the differential motion vector decoder 2130 can generate the codebook of FIG. 11 by sequentially arranging the differential motion vectors in order of the bit string, based on the threshold values of the respective decoded search areas. In this case, the bit strings and the index number (code number) assigned to the respective bit strings may be generated equally to the bit strings and the index number assigned to the respective bit strings used in the differential motion vector encoding apparatus 700.

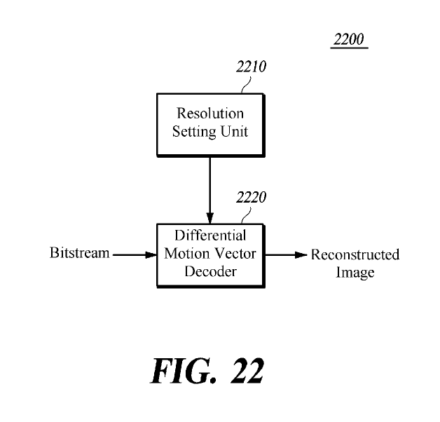

FIG. 22 is a diagram schematically showing a differential motion vector decoding apparatus according to at least one embodiment of the present disclosure. Referring to FIG. 22, the differential motion vector decoding apparatus 2200 according to at least one embodiment may include a resolution setting unit 2210 and a differential motion vector decoder 2220.

The resolution setting unit 2210 may set up motion vector resolutions differentiated by search areas according to threshold values prearranged with the encoder. For example, the resolution setting unit 2210 may prearrange with the encoder to equally set up the respective search areas and the available motion vector resolutions as shown in FIG. 10.

The differential motion vector decoder 2220 extracts the differential motion vector from the bitstream, and decodes the differential motion vector with the resolutions corresponding to the area where the differential motion vector belongs among the respective areas.

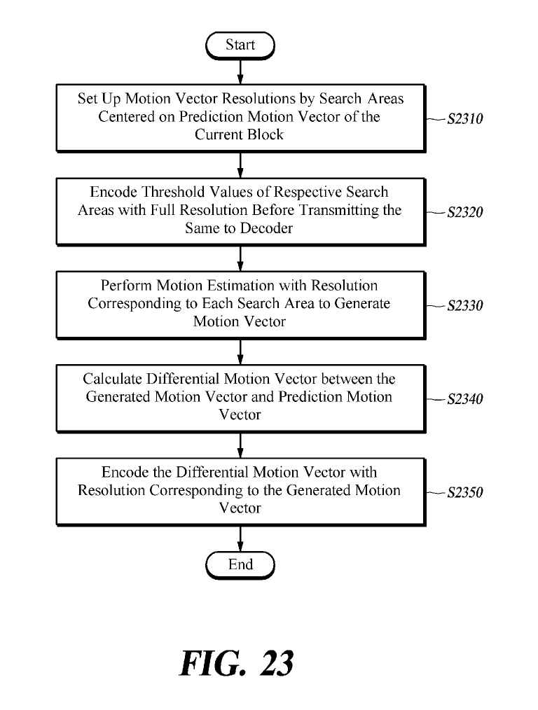

FIG. 23 is a flow diagram showing a differential motion vector encoding method which is performed by the differential motion vector encoding apparatus of FIG. 7.

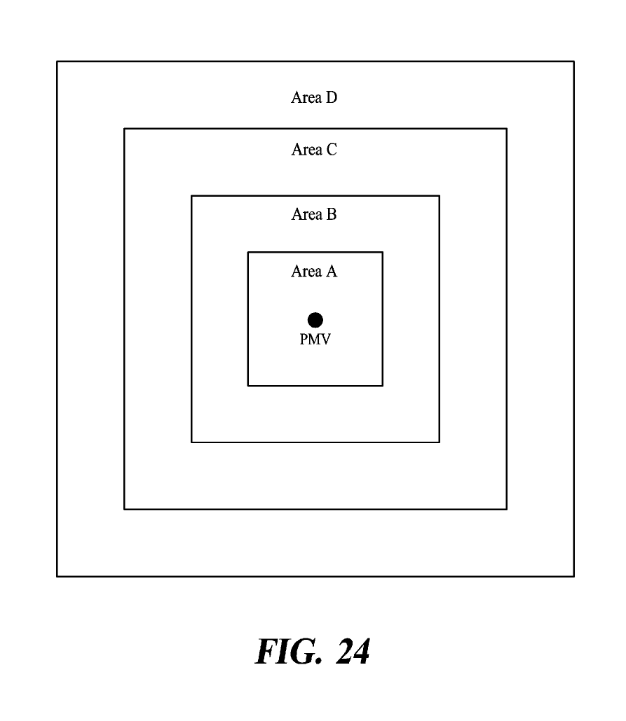

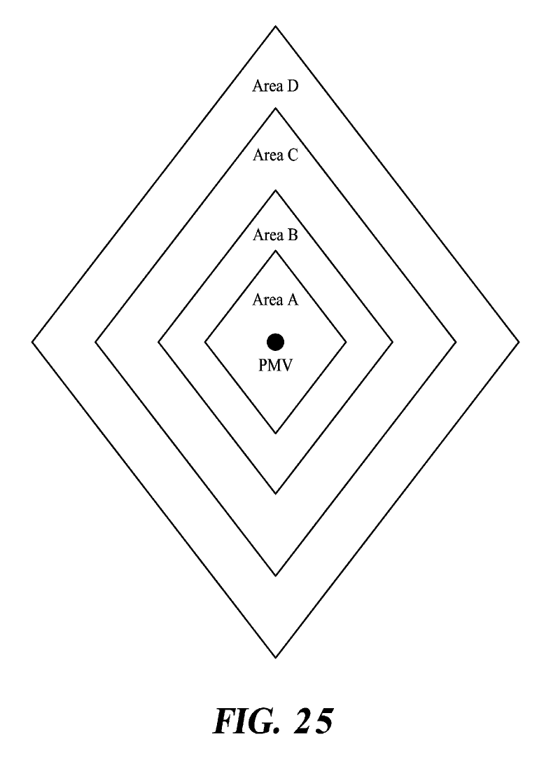

Referring to FIGS. 7 and 23, the resolution setting unit 710 sets up motion vector resolutions differentiated by search areas centered on the prediction motion vector of the current block (S2310). For this purpose, the resolution setting unit 710 may set up resolutions by search areas such that the motion vector resolution is lowered as the distance between the search area and the prediction motion vector increases as illustrated in FIG. 10, or may set up resolutions by search areas such that the motion vector resolution is increased as the distance between the search area and the prediction motion vector of the current block increases as illustrated in FIG. 12. Alternatively, the present disclosure is not limited thereto, available resolutions can be variously set up according to the distance from the prediction motion vector of the current block. In addition, motion vector resolutions differentiated by search areas can be set differently in different directions centered on the prediction motion vector of the current block. For example, the shape of the search areas can be set as shown in FIGS. 24 and 25. FIG. 24 is a diagram showing a case where the search areas are set in a rectangular shape, and FIG. 25 is a diagram showing a case where the search areas are set in a diamond shape. If the search areas are encoded two-dimensionally in this manner, it may be easier to compress motion vectors. For example, when the resolution is determined by the method proposed in FIG. 10 and then used, the differential motion values in both x-axis and y-axis can be one-dimensionally encoded through the method of FIG. 11. However, in the two-dimension encoding/decoding, if a larger difference value is found among the differential motion values of x-axis and y-axis, the smaller difference value can be immediately calculated using its own resolution. For example, if the differential motion value for x-axis is in the area B and the differential motion value for y-axis is in the area A, the differential motion vector currently encoded with the differential motion value for x-axis has been considered with the motion resolution up to ¼. Therefore, instead of the codebook considering up to ⅛, the codebook considering up to ¼ can be used for y-axis. Furthermore, the differential motion vector encoding according to at least one embodiment of the present disclosure can set the search areas in various methods, and there is no limitation to the method for setting the search areas.

The resolution setting unit 710 can calculate the threshold values of the respective search areas by using the current image and the reference image. The present disclosure does not limit the method for calculating the threshold values, and can generate a table (codebook) for encoding the differential motion vector by using the threshold values of the determined search area.

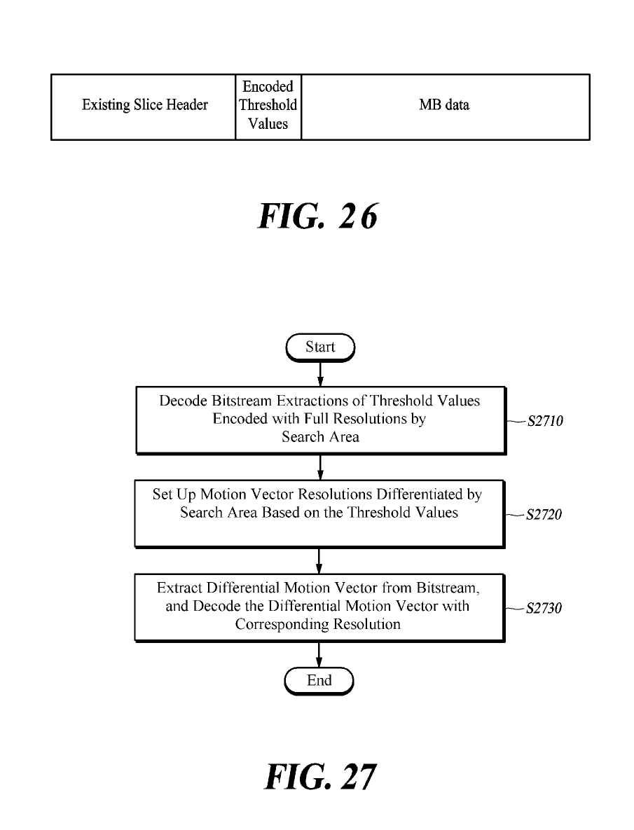

The threshold value encoder 750 encodes the threshold values of the respective search areas with the highest resolution of the corresponding search area and transmits a bitstream to the decoder (S2320). In at least one, when it is necessary to transmit the threshold values, the threshold value encoder 750 encodes the threshold value(s) and inserts the encoded threshold value(s) between a slice header and a coding unit block (MB data) before transmission as shown in FIG. 26. The encoded threshold value(s) is decoded by the decoder and is used to decode a current block/frame.

FIG. 26 shows a method for adding the encoded threshold value(s) to the slice header before transmission in the differential motion vector encoding method according to at least one embodiment of the present disclosure. As shown in FIG. 26, the above-described threshold value(s) behind the slice header is encoded and transmitted.

Instead of notifying the decoder of the threshold values of the respective search areas through the threshold value encoder 750, the resolution setting unit 710 may be configured to set up motion vector resolutions differentiated by search areas according to threshold values representing search area ranges prearranged with the decoder. In this case, the encoding of the threshold values may be omitted.

The motion estimation unit 720 generates the motion vector by performing motion estimation with the resolutions corresponding to the respective search areas set by the resolution setting unit 710 (S2330).

The differential motion vector calculator 730 calculates the differential motion vector between the motion vector generated by the motion estimation unit 720 and the prediction motion vector (S2340).

The differential motion vector encoder 740 encodes the differential motion vector, which is calculated by the differential motion vector calculator 730, with the resolution corresponding to the motion vector generated by the motion estimation unit 720 (S2350).

FIG. 27 is a flow diagram showing a differential motion vector decoding method which is performed by the differential motion vector decoding apparatus as shown in FIG. 21.

Referring to FIGS. 21 and 27, the threshold value decoder 2110 extracts the threshold values by search areas from the bitstream received from the encoder, and decodes the extracted threshold values (S2710).

The resolution setting unit 2120 sets up motion vector resolutions differentiated by search areas based on the respective threshold values decoded by the threshold value decoder 2110 (S2720). That is, the resolution setting unit 2120 can recognize motion vector resolutions available in the respective search areas set by the differential motion vector encoding apparatus 700, based on the respective decoded threshold values.

The differential motion vector decoder 2130 extracts the differential motion vector from the bitstream, and decodes the differential motion vector with the resolution corresponding to the search area where the differential motion vector belongs among the respective search areas (S2730). In at least one embodiment, the differential motion vector decoder 2130 can generate the codebook of FIG. 11 by sequentially arranging the differential motion vectors in order of the bit string, based on the decoded threshold values of the respective search areas. In this case, the bit strings and the index number (code number) assigned to the respective bit strings may be generated equally to the bit strings and the index number assigned to the respective bit strings used in the differential motion vector encoding apparatus 700.

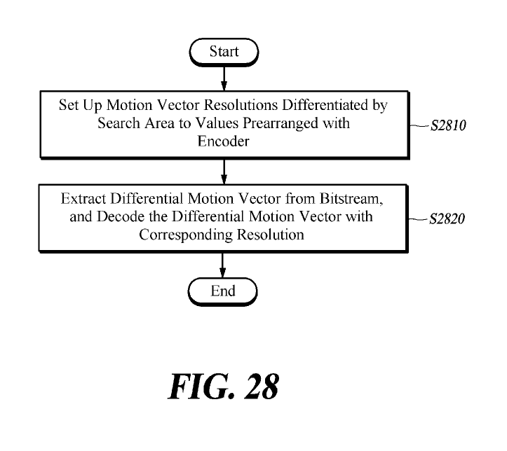

FIG. 28 is a flow diagram showing a differential motion vector decoding method which is performed by the differential motion vector decoding apparatus of FIG.

Referring to FIGS. 22 and 28, the resolution setting unit 2210 sets up motion vector resolutions differentiated by search areas to values prearranged with the encoder (S2810). For example, the resolution setting unit 2210 may prearrange with the encoder to equally set up respective search areas and the available motion vector resolutions as shown in FIG. 10.

The differential motion vector decoder 2220 extracts the differential motion vector from the bitstream, and decodes the differential motion vector with the resolution corresponding to the search area where the differential motion vector belongs among the respective search areas (S2820).

Next, in a case where a video is compressed and decoded using a plurality of reference images, a method for using threshold values will be described. For decoding the current image, information is read from the slice header, the threshold value(s) is read, and data of the coding unit block is read. In this case, the decoded threshold value(s) is used for the respective reference images so as to decode the current frame through the motion compensation.

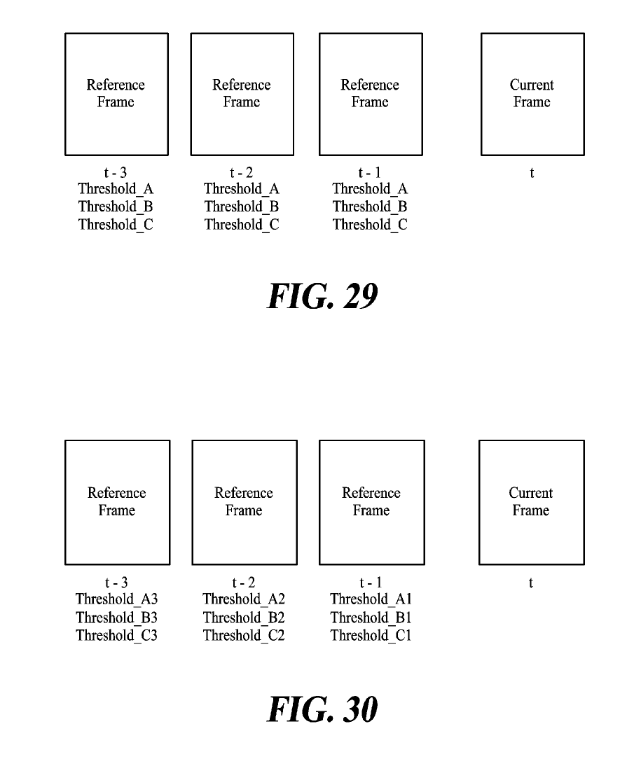

FIG. 29 is a diagram showing an example where all currently encoded threshold values are equally (i.e., commonly) used in various, e.g., all, reference frames. FIG. 30 shows another example in which when various reference images are used, different threshold values are used according to the characteristics of the reference images.

According to the present disclosure as described above, motion vectors are predicted with resolutions differentiated by search areas, and a differential motion vector is adaptively encoded/decoded with a corresponding resolution, increasing compression and reconstruction efficiency in the case of using variable length codebooks.

In the description above, although all of the components of the embodiments of the present disclosure may have been explained as assembled or operatively connected as a unit, one of ordinary skill would understand the present disclosure is not limited to such embodiments. Rather, within some embodiments of the objective scope of the present disclosure, the respective components are selectively and operatively combined in any numbers of ways. Every one of the components are capable of being implemented alone in hardware or combined in part or as a whole and implemented in a computer program having program modules residing in computer readable media and causing a processor or microprocessor to execute functions of the hardware equivalents. The computer program is stored in a non-transitory computer readable media, which in operation realizes at least one embodiments of the present disclosure. The computer readable media include, but are not limited to, magnetic recording media, and optical recording media, in some embodiments.

In addition, one of ordinary skill would understand terms like ‘include’, ‘comprise’, and ‘have’ to be interpreted in default as inclusive or open-ended rather than exclusive or close-ended unless expressly defined to the contrary. All the terms that are technical, scientific or otherwise agree with the meanings as understood by a person skilled in the art unless defined to the contrary.

Although exemplary embodiments of the present disclosure have been described for illustrative purposes, those skilled in the art will appreciate that various modifications, additions and substitutions are possible, without departing from the various characteristics of the disclosure. Therefore, exemplary embodiments of the present disclosure have been described for the sake of brevity and clarity. Accordingly, one of ordinary skill would understand the scope of the disclosure is not to be limited by the explicitly described above embodiments.

1. (canceled)

2. A video encoding apparatus, comprising:
a resolution setting unit configured to set up the motion vector resolutions differentiated by search areas;
a motion estimation unit configured to generate the motion vector by performing motion estimation with the resolution corresponding to each of the search areas;
a differential motion vector calculator configured to calculate the differential motion vector between the generated motion vector and the prediction motion vector; and
a differential motion vector encoder configured to encode the calculated differential motion vector with the resolution corresponding to the generated motion vector.

3. The video encoding apparatus of claim 2, further comprising a threshold value encoder configured to
encode threshold values of the respective search areas with a maximum resolution of the corresponding search area, and
transmit a bitstream including the encoded threshold values to a decoder.

4. The video encoding apparatus of claim 2, wherein the resolution setting unit is configured to set up the motion vector resolutions differentiated by the search areas according to values prearranged with a decoder.

5. The video encoding apparatus of claim 2, wherein the resolution setting unit is configured to set up the resolutions by the search areas such that the motion vector resolutions are lowered as a distance from a current block increases.

6. The video encoding apparatus of claim 2, wherein the resolution setting unit is configured to set up the resolutions by the search areas such that the motion vector resolutions are increased as a distance from a current block increases.

7. The video encoding apparatus of claim 2, wherein the resolution setting unit is configured to set up motion vector resolutions differentiated by the search areas differently according to directions from a current block.

8. A video decoding apparatus, comprising:
a resolution setting unit configured to set up motion vector resolutions differentiated by search areas, based on respective threshold values; and
a differential motion vector decoder configured to extract the differential motion vector from a bitstream, and to decode the extracted differential motion vector with the resolution corresponding to the search area where the differential motion vector belongs to among the search areas.

9. The video decoding apparatus of claim 8, further comprising:
a threshold value decoder configured to extract threshold values encoded with a maximum resolution for each of search areas from the bitstream and to decode the extracted threshold values,
wherein the resolution unit is configured to set up motion resolutions based on the decoded threshold values by the threshold value decoder.

10. The video decoding apparatus of claim 8, wherein the threshold values are prearranged with an encoder transmitting the bitstream.

11. A differential motion vector encoding method comprising:
setting up motion vector resolutions differentiated by the search areas;
performing motion estimation with the resolution corresponding to each of the search areas to generate a motion vector;
calculating a differential motion vector between the generated motion vector and the prediction motion vector; and
encoding the calculated differential motion vector.

12. The differential motion vector encoding method of claim 11, further comprising:
encoding threshold values of the respective search areas with a maximum resolution of the corresponding search area, and
transmitting a bitstream including the encoded threshold values to a decoder.

13. The differential motion vector encoding method of claim 11, wherein the setting up sets up the motion vector resolutions differentiated by the search areas according to values prearranged with a decoder.

14. The differential motion vector encoding method of claim 11, wherein the setting up sets up the resolutions by the search areas such that the motion vector resolutions are lowered as a distance from a current block increases.

15. The differential motion vector encoding method of claim 11, wherein the setting up sets up the resolutions by the search areas such that the motion vector resolutions are increased as a distance from a current block increases.

16. The differential motion vector encoding method of claim 11, wherein the setting up sets up motion vector resolutions differentiated by the search areas differently according to directions from a current block.

17. The differential motion vector encoding method of claim 11, wherein the differential motion vector is encoded with the resolution corresponding to the generated motion vector.

18. A differential motion vector decoding method, comprising:
dividing search areas in accordance with threshold values;
setting up motion vector resolutions differentiated by the search areas;
extracting a differential motion vector from a bitstream; and
decoding an extracted differential motion vector with the resolution corresponding to a search area where the differential motion vector belongs to among the search areas.

19. The differential motion vector decoding method of claim 18, further comprising:
extracting the threshold values encoded with a maximum resolution for each of the search areas from the bitstream; and
decoding the extracted threshold values.

20. The differential motion vector decoding method of claim 18, wherein the threshold values are prearranged with an encoder transmitting the bitstream.
